(19) United States
(12) Patent Application Publication
(10) Pub. No.: US 2021/0245334 A1
(43) Pub. Date: Aug. 12, 2021

(54) HAND TOOL STRUCTURE

(71) Applicant: Tzu Yu Chen, Taichung City (TW)

(72) Inventor: Tzu Yu Chen, Taichung City (TW)

(21) Appl. No.: 16/788,583

(22) Filed: Feb. 12, 2020

(51) Int. Cl. B25B 7/22; B25B 7/12; H02G 1/12

(52) U.S. Cl. CPC B25B 7/22; H02G 1/1212; B25B 7/123

(57) ABSTRACT

A hand tool structure has two plier bodies pivoted by a pivot member, and a knob mechanism for controlling opening and closing of the two plier bodies. The pivot member includes a cylindrical body pivoted to the two plier bodies and a spring sleeved onto the cylindrical body and having two ends abutting against the two plier bodies. Opposing sides of the two plier bodies each include a V- shaped groove to form a square clamping hole when the two plier bodies are closed; a row of teeth; a first cutting portion for cutting an electric wire or cable; a second cutting portion for cutting a metal wire; a wavy peeling portion for peeling a jacket of the electric wire, the peeling portion including curved sections each having a different radius of curvature, wherein when the two plier bodies are closed, the curved sections form receiving holes with different diameters.

### FIELD OF THE INVENTION

The present invention relates to hand tools, and more particularly to a pair of pliers.

### BACKGROUND OF THE INVENTION

Pliers are commonly used hand tools in our daily life, comprising two plier bodies that are intersected and pivoted together. By pivoting the two plier bodies to be opened and closed, pliers can perform some functions, such as gripping small objects and holding objects. For achieving various functions of pliers, there are many types of pliers, such as pliers that can be used to cut wires or screws and pliers that can be used to peel the jackets of electric wires.

However, a pair of pliers usually has only one special function and cannot be used for other purposes. Therefore, people need to buy many different pliers to meet their needs. It is inconvenient for storage and use. Accordingly, the inventor of the present invention has devoted himself based on his many years of practical experiences to solve these problems.

### SUMMARY OF THE INVENTION

The primary object of the present invention is to provide a hand tool structure having various functions, such as clamping and cutting electric wires or screws, peeling the jackets of electric wires, and so on, which is very convenient to use.

In order to achieve the above object, the present invention provides a hand tool structure, comprising a first plier body and a second plier body that are pivotally connected by a pivot member, and a knob mechanism configured to control opening and closing of the first plier body and the second plier body.

The pivot member includes a cylindrical body and a spring. The cylindrical body has two ends pivotally connected to the first plier body and the second plier body. The spring is sleeved onto the cylindrical body. Two ends of the spring abut against the first plier body and the second plier body, respectively, for the first plier body and the second plier body to be opened normally.

The knob mechanism includes two positioning holes disposed on the second plier body and a knob pivotally connected to the second plier body. When the first plier body and the second plier body are relatively closed, the knob is pushed to a first position to be engaged in an engaging slot of the first plier body, so that the first plier body is blocked and cannot be pivoted relative to the second plier body. When the knob is pushed to a second position to be disengaged from the engaging slot, the first plier body can be pivoted relative to the second plier body. The knob has a positioning block extending downward. The positioning block is selectively engaged in one of the positioning holes when the knob is pushed to the first position or the second position;

Opposing sides of the first plier body and the second plier body each include a V- shaped groove, wherein when the first plier body and the second plier body are closed, the V- shaped grooves of the first plier body and the second plier body jointly form a square clamping hole; a row of teeth; a first cutting portion for cutting an electric wire or cable; a second cutting portion for cutting a metal wire, wherein the second cutting portion has a length less than that of the first cutting portion; a wavy peeling portion for peeling a jacket of the electric wire, the peeling portion including a plurality of curved sections each having a different radius of curvature, wherein when the first plier body and the second plier body are closed, the curved sections jointly form a plurality of receiving holes with different diameters.

Preferably, front ends of the first plier body and the second plier body each have an edge.

Preferably, the first plier body and the second plier body each have a plurality of screw cutting holes.

Preferably, the opposing sides of the first plier body and the second plier body have a protrusion and a groove for assembling a terminal.

### BRIEF DESCRIPTION OF THE DRAWINGS

FIG. 1 and FIG. 2 are exploded views of the present invention;

FIG. 3 is a planar view of the present invention;

FIG. 4 is an exploded view of the knob mechanism of the present invention;

FIG. 5, FIG. 6 and FIG. 7 are cross-sectional views of the knob mechanism of the present invention when in use.

### DETAILED DESCRIPTION OF THE PREFERRED EMBODIMENTS

Embodiments of the present invention will now be described, by way of example only, with reference to the accompanying drawings.

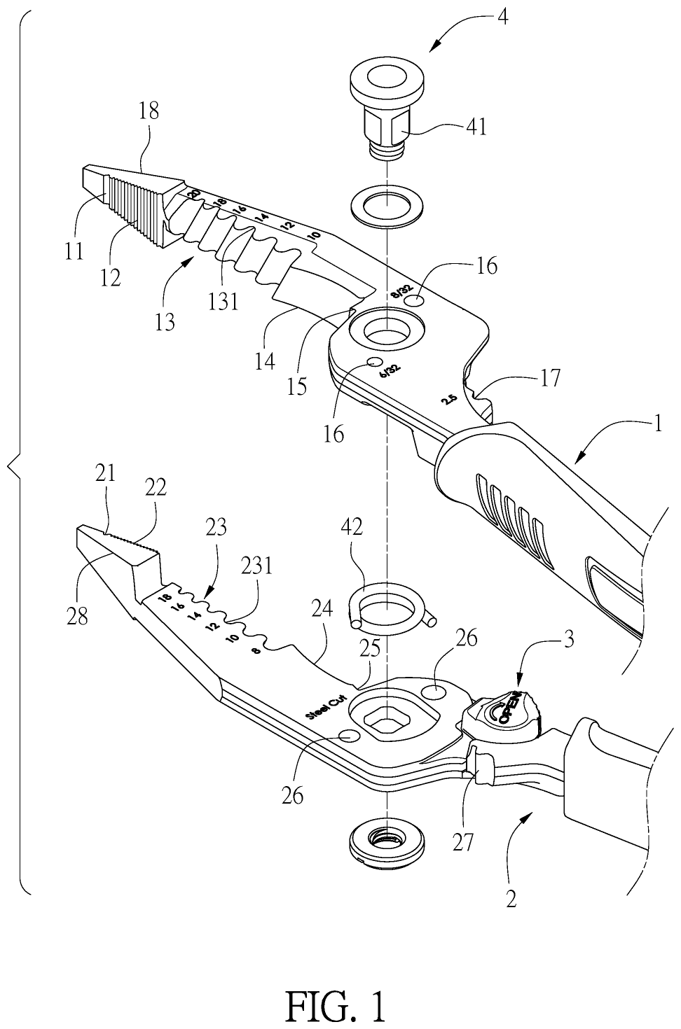

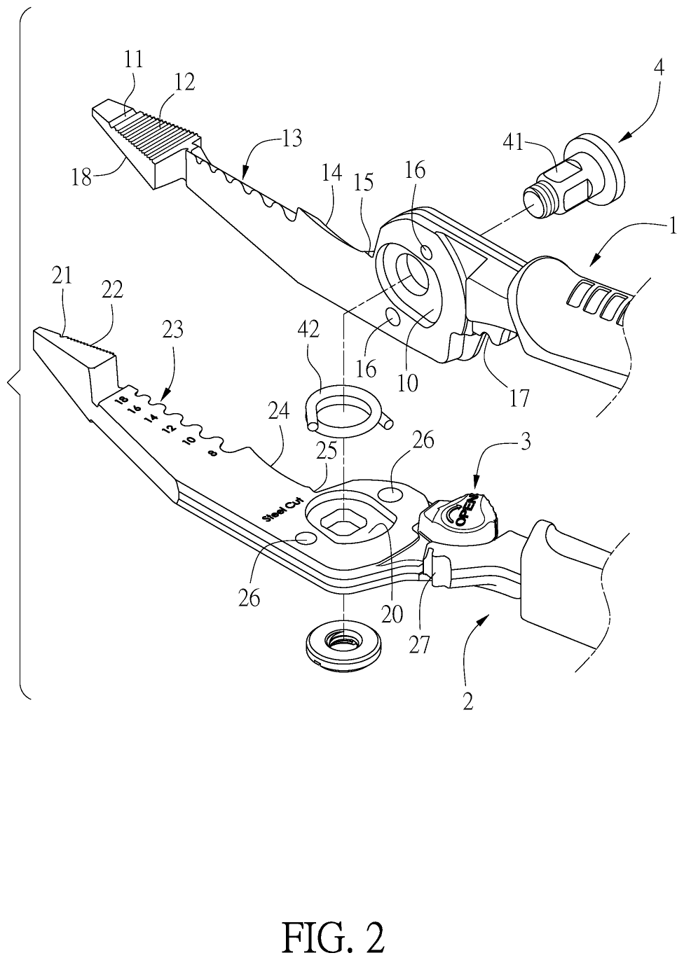

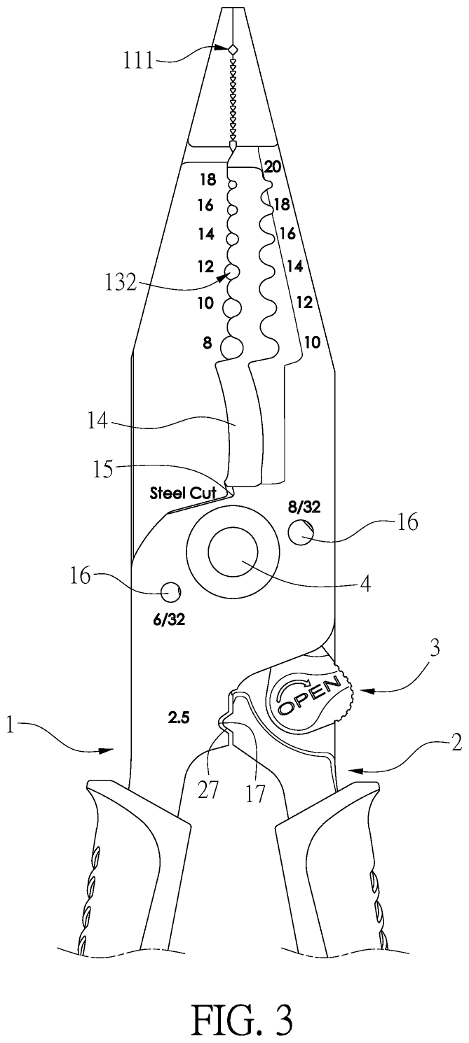

Referring to FIG. 1 through FIG. 3, a hand tool structure according to a preferred embodiment of the present invention comprises a first plier body 1 and a second plier body 2 that are pivotally connected by a pivot member 4, and a knob mechanism 3 configured to control opening and closing of the first plier body 1 and the second plier body 2. The pivot member 4 includes a cylindrical body 41 and a spring 42. The cylindrical body 41 has two ends pivotally connected to the first plier body 1 and the second plier body 2. The spring 42 is sleeved onto the cylindrical body 41. The first plier body 1 and the second plier body 2 have recesses 10, 20, respectively. The spring 42 is accommodated in the recesses 10, 20. Two ends of the spring 42 abut against the side walls of the recesses 10, 20, respectively. The spring 42 normally pushes against the first plier body 1 and the second plier body 2 through its elastic force, so that the first plier body 1 and the second plier body 2 are normally opened, thereby facilitating continuous use and saving the operator's physical strength.

The front ends of opposing sides of the first plier body 1 and the second plier body 2 are formed with V-shaped grooves 11, 21. When the first plier body 1 and the second plier body 2 are closed, the V-shaped grooves 11, 12 jointly form a square clamping hole 111 for clamping small objects, such as wires, etc. The first plier body 1 and the second plier body 2 each have a row of teeth 12, 22 adjacent to the V-shaped grooves 11, 12 for clamping an object firmly when the first plier body 1 and the second plier body 2 are closed. The outer sides of the front ends of the first plier body 1 and the second plier body 2 have sharp edges 18, 28 for scraping off foreign objects on the object.

The first plier body 1 and the second plier body 2 each have a peeling portion 13, 23 adjacent to the row of teeth 12, 22 for peeling the jacket of an electric wire. The peeling portion 13, 23 is wavy and has a plurality of curved sections 131, 231. Each of the curved sections 131, 231 has a different radius of curvature. When the first plier body 1 and the second plier body 2 are closed, the curved sections 131, 231 jointly form a plurality of receiving holes 132 with different diameters. After an electric wire is inserted into the corresponding curved sections 131, 231 and the first plier body 1 and the second plier body 2 are closed, only the jacket of the electric wire is cut without damaging the metal core of the electric wire, thereby achieving the purpose of convenient peeling. The first plier body 1 and the second plier body 2 each have a first cutting portion 14, 24 adjacent to the peeling portion 13, 23 for cutting wires or cables. The first plier body 1 and the second plier body 2 each have a second cutting portion 15, 25 for cutting metal wires. The second cutting portion 15, 25 has a length less than that of the first cutting portion 14, 24, and can be used for cutting electric wires, cables, or metal wires.

The first plier body 1 and the second plier body 2 each have two through screw cutting holes 16, 26 located beside the pivot member 4. The screw cutting holes 16, 26 have different hole diameters for screws of different specifications. The first plier body 1 and the second plier body 2 have a protrusion 27 and a groove 17 located close to the screw cutting holes 16, 26 and used for assembling a terminal.

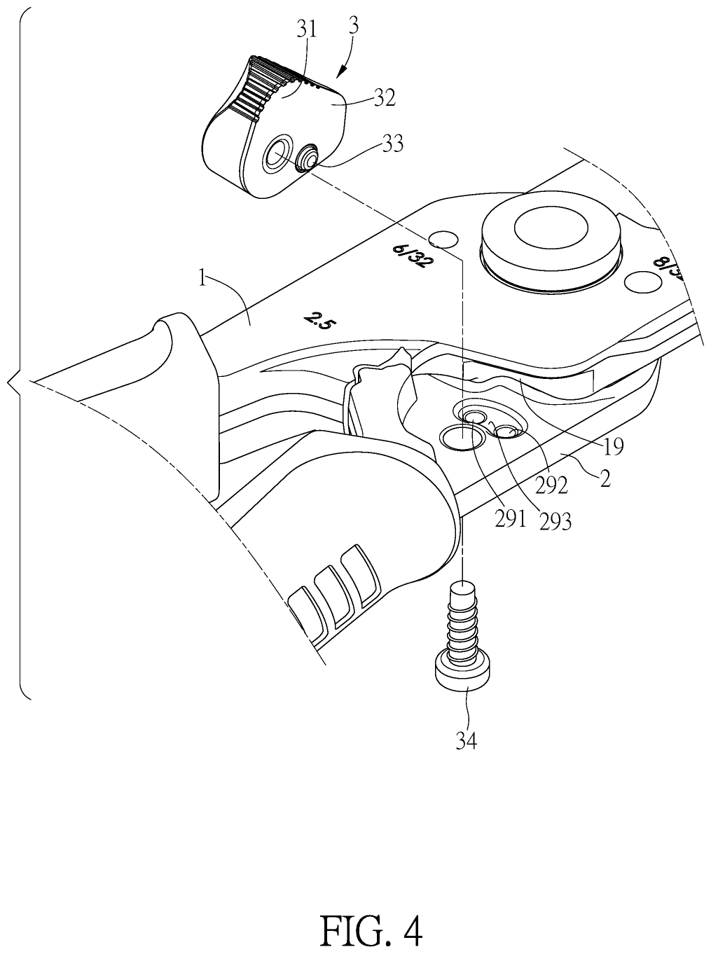

Furthermore, as shown in FIG. 4, the knob mechanism 3 for controlling the opening and closing of the first plier body 1 and the second plier body 2 is disposed on the second plier body 2 near the pivot member 4 and includes a knob 31. In this embodiment, one side of the first plier body 1, close to the pivot member 4, is formed with an engaging slot 19. The knob 31 has a stop portion 32, and is pivotally connected to the second plier body 2 near the pivot member 4 by a pivot shaft 34, and can be pushed to a first position and a second position. When the first plier body 1 and the second plier body 2 are relatively closed, the knob 31 is defined to be pushed to the first position and the stop portion 32 is engaged in the engaging slot 19 of the first plier body 1, so that the first plier body 1 is blocked and cannot be pivoted relative to the second plier body 2, thereby preventing the first plier body 1 and the second plier body 2 from being relatively opened. In this embodiment, the knob 31 has a smooth external curve. When the stop portion 32 is engaged in the engaging slot 19, the knob 31 abuts against the first plier body 1 without a gap, which can avoid hooking foreign objects when in use to affect operation. On the other hand, when the knob 31 is defined to be in the second position, the stop portion 32 of the knob 31 is disengaged from the engaging slot 19. At this time, the first plier body 1 is released and can be freely pivoted relative to the second plier body 2.

The second plier body 2 has an elongated groove 29. The elongated groove 29 has a curved shape corresponding to the trajectory of pivoting the knob 31. The elongated groove 29 is provided with a left positioning hole 291, a right positioning hole 292, and a raised portion 293 between the left positioning hole 291 and the right positioning hole 292. The knob 31 has a soft positioning block 33 extending toward the second plier body 2. The positioning block 33 can be engaged in one of the positioning holes along with the push of the knob 31 for positioning the knob 31.

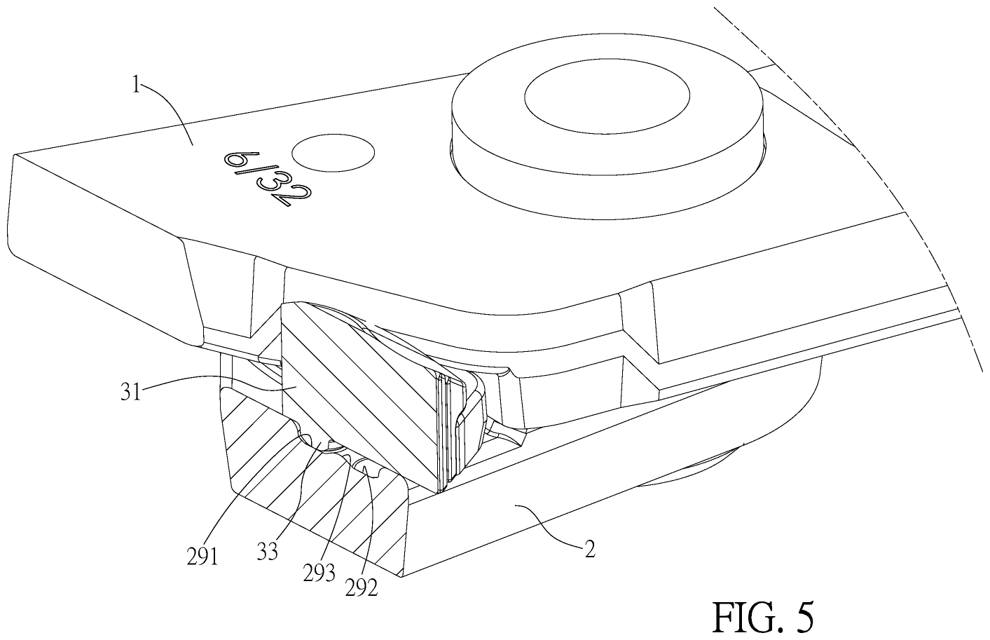

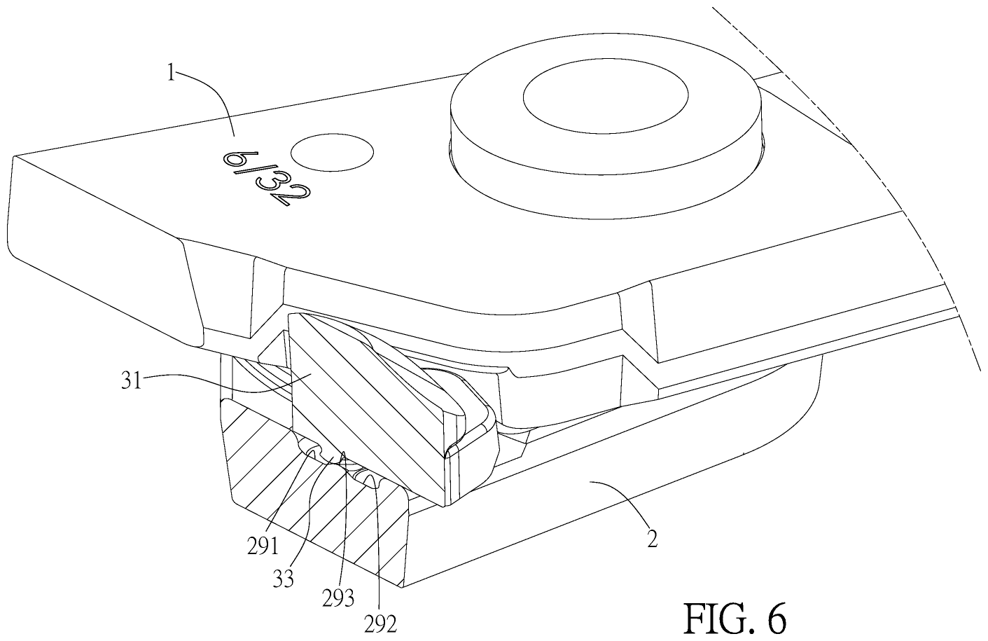

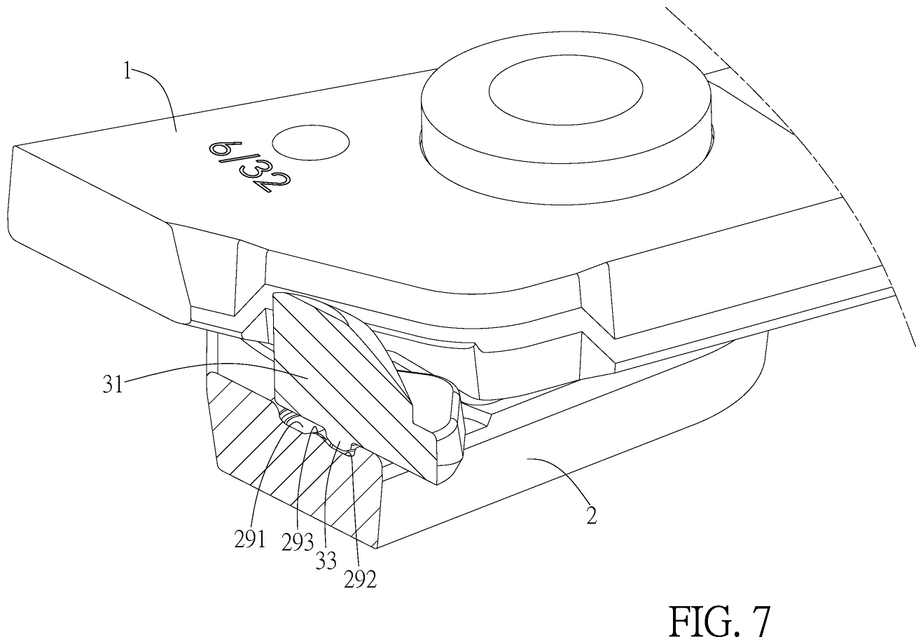

With the above structure, as shown in FIG. 5, when the first plier body 1 and the second plier body 2 are relatively closed and the knob 31 is pushed to the first position to secure the first plier body 1, the positioning block 33 of the knob 31 is engaged in the left positioning hole 291. Through the positioning block 33 confined in the left positioning hole 291, the knob 31 is positioned. Even if the knob 31 is subjected to an external force not exceeding a certain degree, it cannot be pushed. Thereby, the knob 31 can maintain its position and be continuously engaged in the engaging slot, preventing the first plier body 1 from pivoting and undesirably opening the two plier bodies.

On the other hand, the user can apply an external force to the knob 31 for the knob 31 to be pushed from the first position to the second position. The knob 31 is disengaged from the engaging slot, so that the first plier body 1 can be freely pivoted relative to the second plier body 2. At this time, as shown in FIG. 6, during the movement of the knob 31, the positioning block 33 leaves the left positioning hole 291. Because the positioning block 33 is soft and deformable after being compressed, the positioning block 33 is moved over the raised portion 293 to the right positioning hole 292 and engaged in the right positioning hole 292, as shown in FIG. 7. Therefore, the knob 31 is positioned in the second position. As described above, the knob 31 will not be pushed by a slight external force, so as to prevent it from being engaged in the engaging slot by mistake to result in that the two plier bodies cannot be operated.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A hand tool structure, comprising a first plier body and a second plier body that are pivotally connected by a pivot member, and a knob mechanism configured to control opening and closing of the first plier body and the second plier body;
the pivot member including a cylindrical body and a spring, the cylindrical body having two ends pivotally connected to the first plier body and the second plier body, the spring being sleeved onto the cylindrical body, two ends of the spring abutting against the first plier body and the second plier body respectively for the first plier body and the second plier body to be opened normally;
the knob mechanism including two positioning holes disposed on the second plier body and a knob pivotally connected to the second plier body; wherein when the first plier body and the second plier body are relatively closed, the knob is pushed to a first position to be engaged in an engaging slot of the first plier body, so that the first plier body is blocked and cannot be pivoted relative to the second plier body; wherein when the knob is pushed to a second position to be disengaged from the engaging slot, the first plier body can be pivoted relative to the second plier body; the knob having a positioning block extending downward, the positioning block being selectively engaged in one of the positioning holes when the knob is pushed to the first position or the second position;
opposing sides of the first plier body and the second plier body each including:
a V-shaped groove, wherein when the first plier body and the second plier body are closed, the V-shaped grooves of the first plier body and the second plier body jointly form a square clamping hole;
a row of teeth;
a first cutting portion for cutting an electric wire or cable;
a second cutting portion for cutting a metal wire, wherein the second cutting portion has a length less than that of the first cutting portion;
a wavy peeling portion for peeling a jacket of the electric wire, the peeling portion including a plurality of curved sections each having a different radius of curvature, wherein when the first plier body and the second plier body are closed, the curved sections jointly form a plurality of receiving holes with different diameters.

2. The hand tool structure as claimed in claim 1, wherein front ends of the first plier body and the second plier body each have an edge.

3. The hand tool structure as claimed in claim 1, wherein the first plier body and the second plier body each have a plurality of screw cutting holes.

4. The hand tool structure as claimed in claim 1, wherein the opposing sides of the first plier body and the second plier body have a protrusion and a groove for assembling a terminal.
